(19) United States
(12) Patent Application Publication
(10) Pub. No.: US 2011/0061058 A1
(43) Pub. Date: Mar. 10, 2011

(54) TASK SCHEDULING METHOD AND MULTI-CORE SYSTEM

(75) Inventor: Nobuhiro NONOGAKI, Tokyo (JP)

(73) Assignee: KABUSHIKI KAISHA TOSHIBA, Tokyo (JP)

(21) Appl. No.: 12/768,012

(22) Filed: Apr. 27, 2010

(30) Foreign Application Priority Data
Sep. 7, 2009 (JP) 2009-205907

(51) Int. Cl. G06F 9/50; G06F 9/46

(52) U.S. Cl. 718/104

(57) ABSTRACT

A task scheduling method and multi-core system according to an embodiment of the present invention comprises: in scheduling for selecting a task that is set in an execution state with a microprocessor allocated thereto out of tasks in an executable state, it is determined whether at least one of the tasks in a young generation, for which the number of times of refill performed until a point of scheduling after transitioning from the execution state to a standby state according to release of the microprocessor is smaller than a predetermined number of times, is present and, when at least one of the tasks in the young generation is present, microprocessor is allocated to the task selected from at least one of the tasks of the young generation.

### CROSS-REFERENCE TO RELATED APPLICATIONS

This application is based upon and claims the benefit of priority from the prior Japanese Patent Application No. 2009-205907, filed on Sep. 7, 2009; the entire contents of which are incorporated herein by reference.

### BACKGROUND OF THE INVENTION

1. Field of the Invention

The present invention relates to a task scheduling method and a multi-core system.

2. Description of the Related Art

In a multi-core system in which a plurality of processors share a cache memory and a main memory, it is possible to increase parallelism and improve through put by causing the processors to simultaneously execute a large number of tasks.

However, when a large number of tasks are simultaneously executed, temporal locality and spatial locality fall. Therefore, the tasks interchange cache lines with one another and an efficiency of use of a cache falls. Further, throughput falls because transfer between the cache memory and the main memory causes a bottleneck. Therefore, it is demanded to keep a balance between the parallelism and the efficiency of use of the cache such that as large a number of tasks as possible can be executed in a range in which the efficiency of use of the cache memory does not fall.

Japanese Patent Application Laid-Open No. H06-259395 discloses a technology for monitoring traffic of a bus and scheduling tasks to reduce the traffic. However, in a multi-core system including a cache memory, execution of a new task does not immediately lead to an increase in traffic. An amount of increase in traffic fluctuates according to temporal locality due to the execution of the new task. Therefore, the invention disclosed in Japanese Patent Application Laid-Open No. H06-259395 cannot keep a balance between the parallelism and the efficiency of use of the cache taking into account a characteristic of the cache memory.

Japanese Patent Application Laid-Open No. H06-012325 discloses a technology for managing a list of tasks processed by the same processor to reduce useless interchange of cache memories. This technology is effective when respective processors have cache memories but is ineffective when a plurality of processors share one cache memory.

Japanese Patent Application Laid-Open No. 2002-055966 discloses a technology for detecting a memory area to be accessed by tasks and allocating tasks that access the same area to the same processor as a group to reduce useless interchange of cache memories. This technology is ineffective when a plurality of processors share one cache memory.

### BRIEF SUMMARY OF THE INVENTION

A task scheduling method in a multi-core system including a plurality of processors, a cache memory and a main memory shared by the processors, and a refill counter that counts a number of times of refill that is exchange of data performed by the processors between the cache memory and the main memory according to an embodiment of the present invention comprises:

determining, in scheduling for selecting a task that is set in an execution state with the processors allocated thereto out of tasks in an executable state that are candidates to which the processors are allocated, whether at least one of the tasks of a first type, for which the number of times of refill performed until a point of scheduling after transitioning from the execution state to a standby state according to release of the processors is smaller than a predetermined number of times, is present among the tasks in the executable state; and

allocating the processors to the task selected from at least one of the tasks of the first type, when at least one of the tasks of the first type is present.

### BRIEF DESCRIPTION OF THE DRAWINGS

FIG. 1 is a diagram of the configuration of a multi-core system according to a first embodiment of the present invention;

FIG. 2 is a diagram of an example of a state that tasks could take;

FIG. 3 is a diagram of an example of information stored in a main memory of the multi-core system according to the first embodiment;

FIG. 4 is a flowchart for explaining an example of a flow of operation performed by a scheduler of the multi-core system according to the first embodiment in executing scheduling;

FIG. 5 is a flowchart for explaining an example of a flow of operation performed by a scheduler of a multi-core system according to a second embodiment of the present invention in executing scheduling;

FIG. 6 is a diagram of the configuration of a multi-core system according to a third embodiment of the present invention;

FIG. 7 is a flowchart for explaining an example of a flow of operation performed by a scheduler of the multi-core system according to the third embodiment in executing scheduling;

FIG. 8 is a diagram of the configuration of a multi-core system according to a fourth embodiment of the present invention; and

FIG. 9 is a flowchart for explaining an example of a flow of operation performed by a scheduler of the multi-core system according to the fourth embodiment in executing scheduling.

### DETAILED DESCRIPTION OF THE INVENTION

Exemplary embodiments of a task scheduling method and multi-core system according to the present invention will be explained below in detail with reference to the accompanying drawings. The present invention is not limited to the following embodiments.

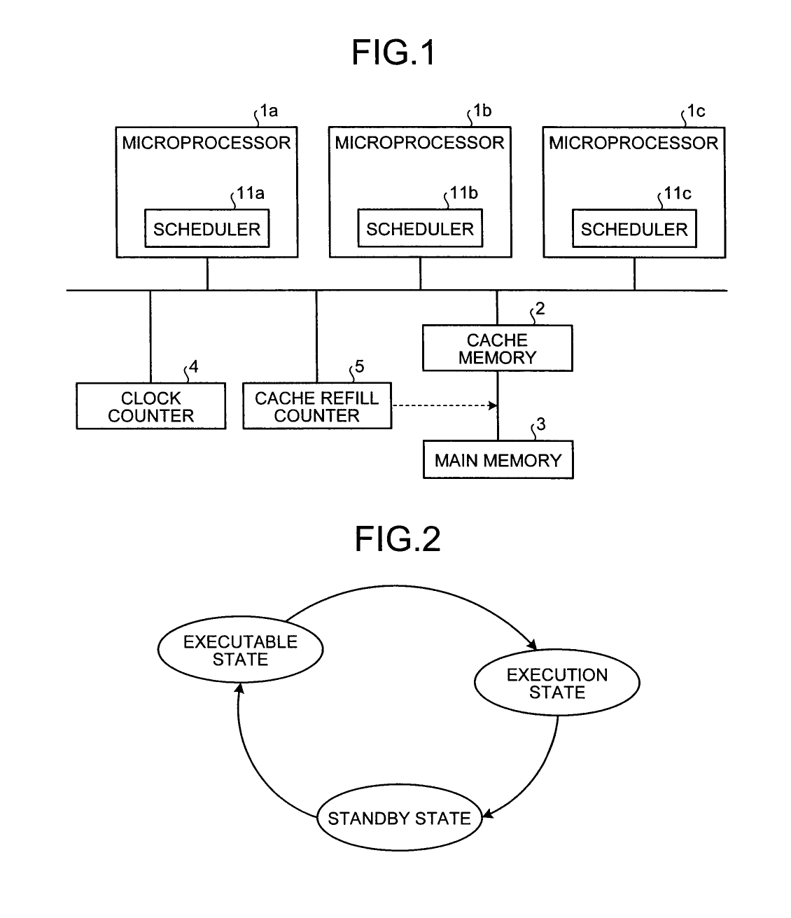

FIG. 1 is a diagram of the configuration of a multi-core system according to a first embodiment of the present invention.

The multi-core system has a multi-processor configuration in which a plurality of microprocessors 1 (1a, 1b, and 1c) share a cache memory 2 and a main memory 3. The multi-core system includes a clock counter 4 and a cache refill counter 5.

The cache refill counter 5 counts the number of times of readout from the main memory 3 by the cache memory 2 and the number of times of writing in the main memory 3 by the cache memory 2. Specifically, the cache refill counter 5 counts once every time the cache memory 2 sends a memory readout request or a memory writing request to the main memory 3 once.

The microprocessors 1a, 1b, and 1c respectively include schedulers 11 (11a, 11b, and 11c). When released from tasks, the microprocessors 1a, 1b, and 1c start the schedulers 11a, 11b, and 11c to execute scheduling. Specifically, when execution of a task ends, each of the microprocessors 1a, 1b, and 1c starts each of the schedulers 11a, 11b, and 11c, selectively acquires a task, which the microprocessor should execute next, from the main memory 3, and allocates the microprocessor itself to the task to execute the task. In the following explanation, except when it is particularly necessary to distinguish the microprocessors 1 and the schedulers 11, suffixes a to c are not affixed to reference signs of the microprocessors 1 and the schedulers 11.

The schedulers 11 can read a count value of the cache refill counter 5. The schedulers 11 can read a count value from the clock counter 4.

The microprocessors 1 and the schedulers 11 are collectively referred to as microprocessor 1 and scheduler 11, respectively. As shown in FIG. 2, tasks could take three states; “an execution state”, “a standby state”, and “an executable state”. A task in the execution state is a task currently executed with the microprocessor 1 allocated thereto. A task in the executable state is a task that can be executed if the scheduler 11 allocates the microprocessor 1 to the task. A task in the standby state is a task suspended from execution because a condition for the execution is not satisfied.

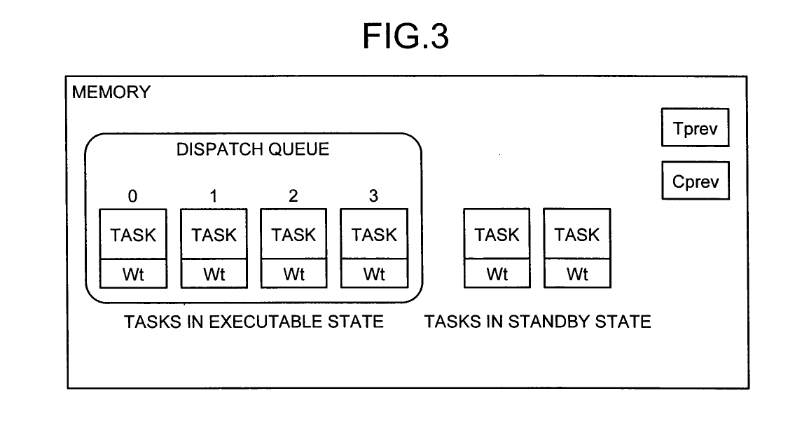

As shown in FIG. 3, information for the scheduler 11 to select a task that should be executed next is recorded in the main memory 3. Specifically, tasks not being executed in the microprocessor 1 are classified into “the executable state” and “the standby state” and stored. The tasks in the executable state are aligned as a dispatch queue in order of transition to the executable state. A value Wt of the cache refill counter 5 at a point when each of the tasks transitions to the standby state is stored in association with the task. The value Wt is used in determining “a task in a young generation” (“a task of a first type”) and “a task in an old generation” (“a task of a second type”) during scheduling. A count value Tprev of the clock counter 4 during the last scheduling and a count value Cprev of the cache refill counter 5 during the last scheduling are stored in the main memory 3.

Two thresholds, i.e., a generation threshold Gth and a cache use threshold α, are set in the scheduler 11 as parameters for scheduling. The generation threshold Gth is set based on a cache capacity at a point when the generation threshold Gth is set. The cache use threshold α is a threshold of the number of times of refill per unit time and is set based on throughput between the cache memory 2 and the main memory 3. Specifically, the scheduler 11 is adjusted by the two parameters according to a characteristic of a system.

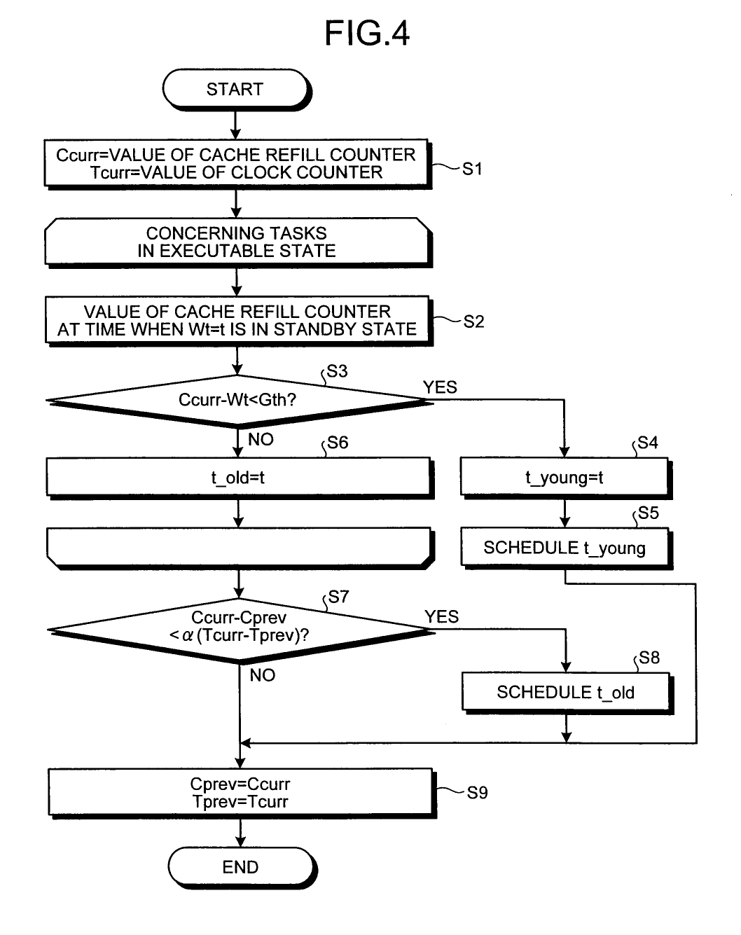

FIG. 4 is a flowchart for explaining a flow of operation performed by the scheduler 11 in executing scheduling (selecting a task to which the microprocessor 1 should be allocated next).

The scheduler 11 reads, in selecting a task that the scheduler 11 causes the microprocessor 1 to execute next out of tasks in the executable state, a current value (Ccurr) of the cache refill counter 5 and a current value (Tcurr) of the clock counter 4 (step S1).

Subsequently, the scheduler 11 reads out, concerning tasks in the executable state, the value Wt from the main memory 3 (step S2). The scheduler 11 compares a difference between the read-out value Wt and the current value (Ccurr) of the cache refill counter 5 with the generation threshold Gth (step S3). When there is a task for which Ccurr−Wt<Gth (“Yes” at step S3), the scheduler 11 determines that the task is “a task in the young generation” (step S4), immediately selects the task, and allocates the microprocessor 1 to the selected task (step S5). On the other hand, in the case of Ccurr−Wt>=Gth for the tasks in the executable state (“No” at step S3), the scheduler 11 determines that the tasks are “tasks in the old generation” (step S6). When the scheduler 11 determines that the tasks are “tasks in the old generation”, the scheduler 11 returns to step S2 and applies the same processing to the other tasks in the executable state. The scheduler 11 repeats the processing until the scheduler 11 determines that a task is a task in the young generation and allocates the microprocessor 1 to the selected task or until the scheduler 11 determines that all the tasks are tasks in the old generation.

When all the tasks in the executable state are “tasks in the old generation”, the scheduler 11 determines whether a relation Ccurr−Cprev<α·(Tcurr−Tprev) holds (whether the number of times of refill per unit time after the last scheduling {(Ccurr−Cprev)/(Tcurr−Tprev)} is smaller than the cache use threshold α) (step S7). When the relation Ccurr−Cprev<α·(Tcurr−Tprev) holds (“Yes” at step S7), the scheduler 11 determines that “a task in the old generation” can be scheduled and allocates the microprocessor 1 to a task that transitions to the executable state first among the tasks in the executable state (i.e., a task at the top of a dispatch queue) (step S8). When the relation Ccurr−Cprev<α·(Tcurr−Tprev) does not hold (“No” at step S7), the scheduler 11 determines that “a task in the old generation” cannot be scheduled and substitutes Ccurr in Cprev and substitutes TCurr in Tprev and stores Ccurr and Tcurr in the main memory 3 for scheduling in the next time (step S9).

When the scheduler 11 allocates the microprocessor 1 to “a task in the young generation” or “a task in the old generation”, the scheduler 11 also substitutes Ccurr in Cprev and substitutes Tcurr in Tprev and stores Ccurr and Tcurr in the main memory 3 for scheduling in the next time (step S9).

According to the operation explained above, “a task in the old generation”, for which cache refill is highly likely necessary, is scheduled only when a degree of use of a cache is low. The microprocessor 1 is allocated to the task.

As explained above, with the multi-core system according to this embodiment, concerning “a task in the old generation”, for which the number of times after transitioning to the standby state is equal to or larger than a predetermined number of times, the scheduler 11 determines that the task can be scheduled only when the number of times of cache refill per unit time is smaller than the cache use threshold α set based on throughput between the cache memory and the main memory. In other words, the scheduler 11 determines a generation of execution of a task using a value of the cache refill counter and changes a scheduling method for each of generations. This makes it possible to maximize the number of tasks simultaneously executed in a range in which a hit ratio of the cache memory can be maintained. In other words, it is possible to keep a balance between the parallelism and the efficiency of use of a cache such that as large a number of tasks as possible can be executed in a range in which the efficiency of use of the cache memory does not fall.

In the example of the configuration shown FIG. 1, the multi-core system includes the clock counter 4 and measures elapsed time from the last scheduling according to a difference between a counter value of the counter 4 during the last scheduling and a counter value of the clock counter 4 during the present scheduling. However, it goes without saying that the same operation can be performed even when a timer is provided instead of the clock counter 4.

The configuration of a multi-core system according to a second embodiment of the present invention is the same as that according to the first embodiment.

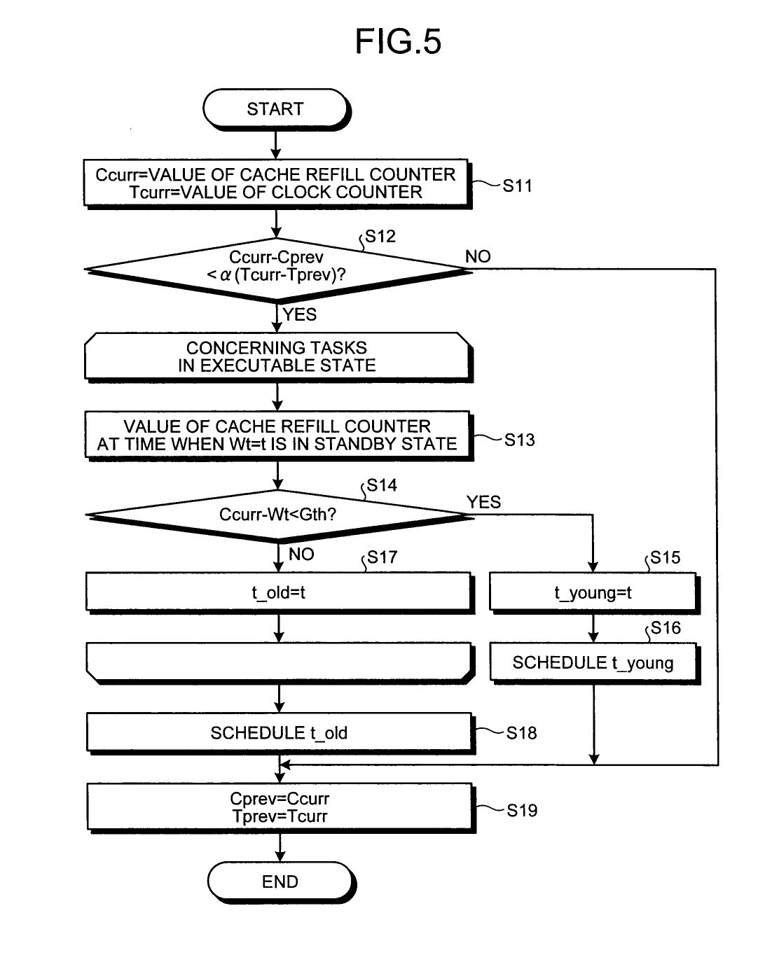

FIG. 5 is a flowchart for explaining a flow of scheduling operation of the multi-core system according to the second embodiment.

The scheduler 11 reads, in selecting a task that the scheduler 11 causes the microprocessor 1 to execute next out of tasks in the executable state, a current value (Ccurr) of the cache refill counter 5 and a current value (Tcurr) of the clock counter 4 (step S11). The scheduler 11 determines whether a relation Ccurr−Cprev<α·(Tcurr−Tprev) holds (whether the number of times of refill per unit time after the last scheduling {(Ccurr−Cprev)/(Tcurr−Tprev)} is smaller than the cache use threshold α) (step S12).

When the relation Ccurr−Cprev<α·(Tcurr−Tprev) holds (“Yes” at step S12), the scheduler 11 reads out, concerning tasks in the executable state, the value Wt from the main memory 3 (step S13). The scheduler 11 compares a difference between the read-out value Wt and the current value (Ccurr) of the cache refill counter 5 with the generation threshold Gth (step S14). When there is a task for which Ccurr−Wt<Gth (“Yes” at step S14), the scheduler 11 determines that the task is “a task in the young generation” (step S15), immediately selects the task, and allocates the microprocessor 1 to the selected task (step S16). On the other hand, in the case of Ccurr−Wt>=Gth for the tasks in the executable state (“No” at step S14), the scheduler 11 determines that the tasks are “tasks in the old generation” (step S17). When the scheduler 11 determines that the tasks are “tasks in the old generation”, the scheduler 11 returns to step S13 and applies the same processing to the other tasks in the executable state. The scheduler 11 repeats the processing until the scheduler 11 determines that a task is a task in the young generation and allocates the microprocessor 1 to the selected task or until the scheduler 11 determines that all the tasks are tasks in the old generation.

When all the tasks in the executable state are “tasks in the old generation”, the scheduler 11 allocates the microprocessor 1 to a task that transitions to the executable state first among the tasks in the executable state (i.e., a task at the top of a dispatch queue) (step S18).

When the relation Ccurr−Cprev<α·(Tcurr−Tprev) does not hold (“No” at step S12), the scheduler 11 determines that a task cannot be scheduled and stores Ccurr in Cprev and stores Tcurr in Tprev for scheduling in the next time (step S19).

When the scheduler 11 allocates the microprocessor 1 to “a task in the young generation” or “a task in the old generation”, the scheduler 11 also substitutes Ccurr in Cprev and substitutes Tcurr in Tprev and stores Ccurr and Tcurr in the main memory 3 for scheduling in the next time (step S19).

In this embodiment, first, the scheduler 11 determines whether the number of times of refill per unit time is smaller than the cache use threshold α (step S12). When the number of times of refill is smaller than the cache use threshold α, the scheduler 11 determines whether the tasks in the executable state are tasks in the young generation or the old generation (step S14).

In other words, in this embodiment, when the number of times of refill per unit time is equal to or larger than the cache use threshold α, the scheduler 11 does not allocate the microprocessor 1 to a task irrespectively of whether a task is a task in the old generation or the young generation.

Therefore, compared with the first embodiment, although operating ratios of the microprocessors are low, the effect of suppressing an increase in the number of times of cache refill is higher. Therefore, it is sufficient to determine which of the embodiments is applied according to which of the operating ratios of the microprocessors and the suppression of an increase in the number of times of refill has priority. For example, when a task for which a delay in execution is not allowed (a task such as streaming processing requiring real time properties) is executed, it is desirable to apply the scheduling operation in this embodiment.

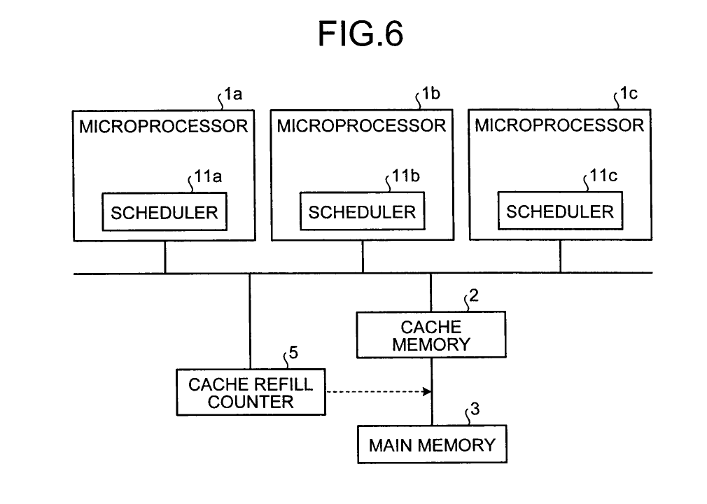

FIG. 6 is a diagram of the configuration of a multi-core system according to a third embodiment of the present invention. The multi-core system according to the third embodiment is different from the multi-core system according to the first embodiment in that the multi-core system does not include the clock counter 4.

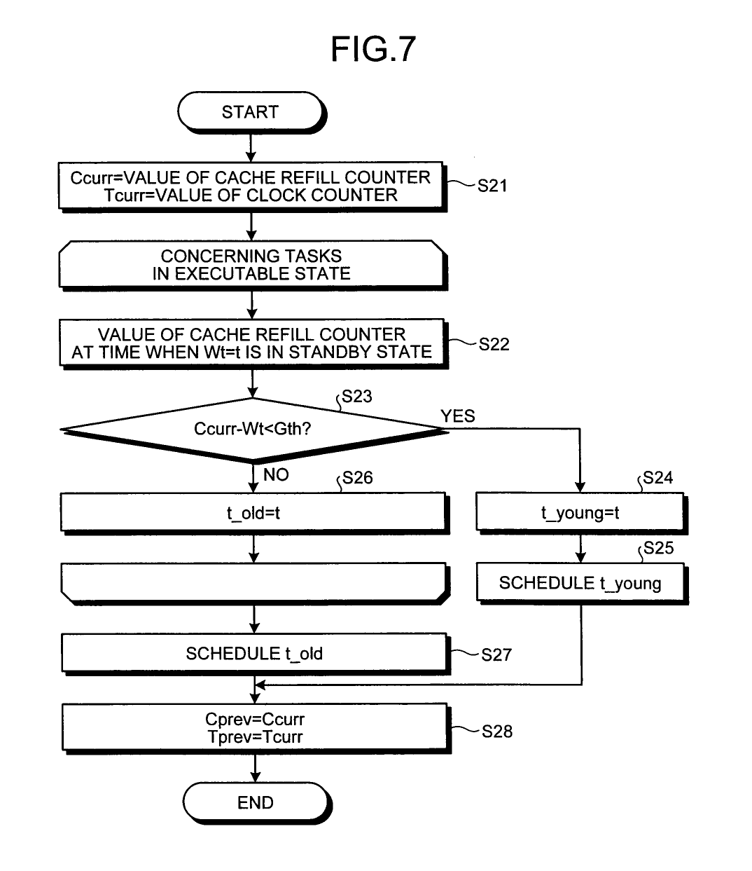

FIG. 7 is a flowchart for explaining operation performed by the scheduler 11 of the multi-core system according to this embodiment in executing scheduling. In the scheduling, as in the first embodiment, the scheduler 11 determines whether the tasks in the executable state are tasks in the young generation (step S23) and, when there is a task in the young generation (step S24), preferentially allocates the microprocessor 1 to the task (step S25). However, in this embodiment, when there is no task in the young generation, the scheduler 11 allocates the microprocessor 1 to a task in the old generation irrespectively of the number of times of refill per unit time (step S27).

This makes it possible to prevent the task in the old generation from being left for a long time without the microprocessor 1 being allocated thereto.

Data necessary in executing a task in the young generation is highly likely to be stored on the cache memory 2. Therefore, presence or absence of a task in the young generation is checked and, when there is a task in the young generation, the microprocessor 1 is preferentially allocated to the task. This makes it possible to keep a balance between the parallelism and the efficiency of use of a cache such that as large a number of tasks as possible can be executed in a range in which the efficiency of use of the cache memory does not fall.

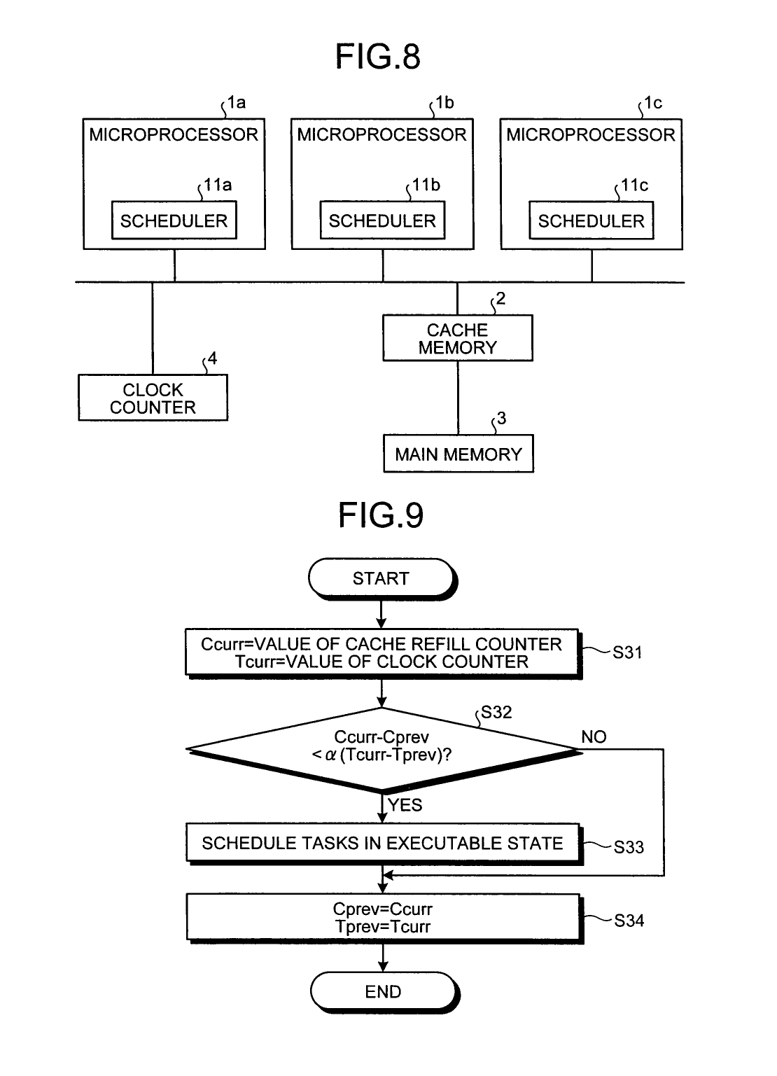

FIG. 8 is a diagram of the configuration of a multi-core system according to a fourth embodiment of the present invention. The multi-core system according to the fourth embodiment is different from the multi-core system according to the first embodiment in that the multi-core system does not include the cache refill counter 5.

FIG. 9 is a flowchart for explaining a flow of operation performed by the scheduler 11 of the multi-core system according to this embodiment in executing scheduling. In the scheduling, as in the second embodiment, the scheduler 11 determines whether the number of times of refill per unit time is smaller than the cache use threshold α (step S32) and, when the number of times of refill per unit time is smaller than the cache use threshold α, allocates the microprocessor 1 to a task in the executable state (step S33). However, in this embodiment, the scheduler 11 does not determine whether the task in the executable state is a task in the old generation or the young generation.

This makes it possible to prevent a task staying in the standby state for a long time from being left without the microprocessor 1 being allocated thereto.

When the number of times of refill per unit time is smaller than the cache use threshold α, even if the microprocessor 1 is allocated to a task requiring refill of a cache, it is less likely that throughput falls because transfer of a cache line between the cache memory 2 and the main memory 3 causes a bottleneck. Therefore, when the number of times of refill per unit time is smaller than the cache use threshold α, the microprocessor 1 is allocated to an arbitrary cache. This makes it possible to keep a balance between the parallelism and the efficiency of use of a cache such that as large a number of tasks as possible can be executed in a range in which the efficiency of use of the cache memory does not fall.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A task scheduling method in a multi-core system including a plurality of processors, a cache memory and a main memory shared by the processors, and a refill counter that counts a number of times of refill that is exchange of data performed by the processors between the cache memory and the main memory, the task scheduling method comprising:
determining, in scheduling for selecting a task that is set in an execution state with the processors allocated thereto out of tasks in an executable state that are candidates to which the processors are allocated, whether at least one of the tasks of a first type, for which the number of times of refill performed until a point of scheduling after transitioning from the execution state to a standby state according to release of the processors is smaller than a predetermined number of times, is present among the tasks in the executable state; and
allocating the processors to the task selected from at least one of the tasks of the first type, when at least one of the tasks of the first type is present.

2. The task scheduling method according to claim 1, further comprising setting the predetermined number of times based on a capacity of the cache memory at the point of the scheduling.

3. The task scheduling method according to claim 1, further comprising allocating, at a point when a task of the first type is detected first, the processors to the detected task of the first type.

4. The task scheduling method according to claim 1, further comprising:
determining, in the scheduling, when all the tasks in the executable state are tasks of a second type, for which the number of times of refill performed until the point of the scheduling after transitioning to the standby state is equal to or larger than the predetermined number of times, whether the number of times of refill performed in a predetermined period until the point of the scheduling is smaller than a predetermined threshold; and
allocating the processors to any one of the tasks of the second type when the number of times of refill is smaller than the threshold and allocating the processors to none of the tasks when the number of times of refill is equal to or larger than the threshold.

5. The task scheduling method according to claim 4, further comprising setting the predetermined threshold based on throughput between the cache memory and the main memory.

6. The task scheduling method according to claim 4, further comprising:
storing the tasks in the executable state as a queue based on order of transition to the executable state; and
allocating, in the scheduling, when all the tasks in the executable state are tasks of the second type, the processors to a task of the second type at a top of the queue.

7. The task scheduling method according to claim 1, further comprising allocating, in the scheduling, when no task of the first type is present among the tasks in the executable state, the processors to any one of the tasks in the executable state.

8. The task scheduling method according to claim 4, wherein the predetermined period is a period from time of execution of last scheduling until time of execution of present scheduling.

9. A task scheduling method in a multi-core system including a plurality of processors, a cache memory and a main memory shared by the processors, and a refill counter that counts a number of times of refill that is exchange of data performed by the processors between the cache memory and the main memory, the task scheduling method comprising:
determining, in scheduling for selecting a task that is set in an execution state with the processors allocated thereto out of tasks in an executable state that are candidates to which the processors are allocated, whether the number of times of refill performed in a predetermined period until a point of the scheduling is smaller than a predetermined threshold; and
allocating the processors to the task selected from at least one of the tasks in the executable state when the number of times of refill is smaller than the threshold and allocating the processors to none of the tasks when the number of times of refill is equal to or larger than the threshold.

10. The task scheduling method according to claim 9, further comprising setting the predetermined threshold based on throughput between the cache memory and the main memory.

11. The task scheduling method according to claim 9, further comprising:
determining, in selecting a task to which the processors are allocated out of the tasks in the executable state, whether at least one of the tasks of a first type, for which the number of times of refill performed until the point of scheduling after transitioning from the execution state to a standby state according to release of the processors is smaller than a predetermined number of times, is present among the tasks in the executable state;
selecting, when at least one of the tasks of the first type is present, any one of the tasks of the first type and allocating the processors to the task; and
allocating, when no task of the first type is present, the processors to any one of tasks of a second type, for which the number of times of refill performed until the point of the scheduling after transitioning to the standby state is equal to or larger than the predetermined number of times.

12. The task scheduling method according to claim 11, further comprising setting the predetermined number of times based on a capacity of the cache memory at the point of the scheduling.

13. The task scheduling method according to claim 11, further comprising allocating, at a point when a task of the first type is detected first, the processors to the detected task of the first type.

14. The task scheduling method according to claim 11, further comprising:
storing the tasks in the executable state as a queue based on order of transition to the executable state; and
allocating, in the scheduling, when no task of the first type is present in the queue, the processors to a task of the second type at a top of the queue.

15. The task scheduling method according to claim 11, further comprising:
storing the tasks in the executable state as a queue based on order of transition to the executable state; and
allocating, in the scheduling, at a point when a task of the first type is detected first, the processors to the detected task of the first type and allocating, when no task of the first type is present in the queue, the processors to a task of the second type at a top of the queue.

16. A multi-core system having a multi-core processor configuration in which a plurality of processors share a cache memory and a main memory, the multi-core system comprising:
a refill counter that measures a number of times of refill that is exchange of data performed by the processors between the cache memory and the main memory; and
a scheduler that operates on the processors and selects a task that is set in an execution state with the processors allocated thereto out of tasks in an executable state that are candidates to which the processors are allocated, wherein
the scheduler includes:
a first determining unit that determines, in the scheduling, whether at least one of the tasks of a first type, for which the number of times of refill performed until a point of the scheduling after transitioning from the execution state to a standby state according to release of the processors is smaller than a predetermined number of times, is present among the tasks in the executable state;
a first allocating unit that selects, when at least one of the tasks of the first type is present, any one of the tasks of the first type and allocates the processors to the task;
a second determining unit that determines, when all the tasks in the executable state at a point of the scheduling are tasks of a second type, for which the number of times of refill performed until the point of the scheduling after transitioning to the standby state is equal to or larger than the predetermined number of times, whether the number of times of refill performed in a predetermined period until the point of the scheduling is smaller than a predetermined threshold; and
a second allocating unit that allocates the processors to none of the tasks when the number of times of refill performing in the predetermined period is equal to or larger than the threshold and allocates the processors to any one of the tasks of the second type only when the number of times of refill performed in the predetermined period is smaller than the threshold.

17. The multi-core system according to claim 16, wherein the predetermined number of times is a value set based on a capacity of the cache memory at the point of the scheduling.

18. The multi-core system according to claim 16, wherein the predetermined threshold is a value set based on throughput between the cache memory and the main memory.

19. The multi-core system according to claim 16, wherein the predetermined period is a period from time of execution of last scheduling until time of execution of present scheduling.

20. The multi-core system according to claim 19, further comprising a clock counter that counts a clock signal, wherein
the scheduler measures the predetermined period according to a difference between a count value of the clock counter at the time of the execution of the last scheduling and a count value of the clock counter at the time the execution of the present scheduling.
